(19) United States
(12) Patent Application Publication
(10) Pub. No.: US 2015/0158204 A1
(43) Pub. Date: Jun. 11, 2015

(54) METHOD AND APPARATUS FOR PRODUCING PLASTIC PREFORMS

(71) Applicant: KRONES AG, Neutraubling (DE)

(72) Inventor: Andreas Kraus, Lappersdorf (DE)

(21) Appl. No.: 14/521,515

(22) Filed: Oct. 23, 2014

(30) Foreign Application Priority Data
Dec. 10, 2013 (DE) 10 2013 113 780.6

(51) Int. Cl. B29B 11/14; B29B 17/00; B29C 49/00; B29B 11/08

(52) U.S. Cl. CPC B29B 11/14; B29B 11/08; B29B 17/00; B29C 49/0005; B29B 2017/001; B29K 2067/003

(57) ABSTRACT

Method for producing a plastic preform, the method comprising a first step of producing a plastic preform from raw material, and a second step of applying an outer layer to the plastic preform, wherein the outer layer forms a bond with the plastic preform, and is insoluble in aqueous solutions having a pH-value between 3 and 10, and well soluble in aqueous solutions having a pH-value in a range of less than 3 and/or more than 10.

### CROSS-REFERENCE TO RELATED APPLICATION

The present application claims priority to German Application No. 10 2013 113 780.6, filed Dec. 10, 2014. The priority application, DE 10 2013 113 780.6 is hereby incorporated by reference.

### FIELD OF THE DISCLOSURE

The present disclosure relates to a method and a corresponding apparatus for producing plastic preforms, e.g. PET preforms.

### BACKGROUND

Methods and apparatus for producing plastic preforms, or preforms, are known from the prior art. Usually, these preforms are produced from plastic flakes or PET flakes, for example within the scope of recycling processes and injection molding technologies, and are shaped into plastic containers subsequently, e.g. by using stretch blow molding technologies. Typically, injection molding processes are employed for this purpose. It is also known to realize this injection molding process with different layers forming the material thickness of the preform, such as, for example, multilayer processes. In this injection molding process used for producing the preform different properties are realized in each layer. As a rule, multilayer processes involve a great expenditure in terms of machines, however, since they require several injection molding units for the production of a preform.

### SUMMARY OF THE DISCLOSURE

Based on the prior art it is one aspect of the present disclosure to realize a method for producing plastic preforms, wherein the subsequent recycling of the containers made from the preforms is simplified.

One method according to the disclosure for producing a plastic preform includes a first step of a production of a plastic preform from raw material, and a second step of applying an outer layer to the plastic preform, where the outer layer forms a bond with the plastic preform, and is insoluble in aqueous solutions having a pH-value between 3 and 10, and well soluble in aqueous solutions having a pH-value in a range of less than 3 and/or more than 10. The plastic preforms are preferably plastic preforms for the production of containers in the beverage-processing industry, wherein the preform may comprise a thread for a screw top. The plastic preform, provided with a corresponding outer layer, can then be directly manufactured into a plastic container, e.g. in a stretch blow molding process, which then has the same outer layer, so that the solubility of the printing inks, which can be applied to the outer layer, in a recycling process is improved as they are well removable, together with the outer layer, by commonly used recycling solutions having pH-values of more than 10 or less than 3 and can, thus, be removed from the plastic container.

In one embodiment the first step comprises the production of a plastic preform by an injection molding process. Thus, the production process of the plastic preform can be performed in the usual manner, except for applying the outer layer.

It may be provided that the outer layer is applied to the plastic preform by at least one of the following method steps: rolling, spraying, dip coating, direct printing, combustion chemical vapor deposition, plasma deposition, electrostatic coating. The use of corresponding apparatus and methods for applying the outer layer can ensure both an application of the outer layer over the full circumference and the application of the outer layer on selected areas.

In one embodiment of the method the outer layer is applied either to a portion of the outer surface of the plastic preform or to the whole outer surface of the plastic preform. Applying the outer layer to the whole surface of the plastic preform allows the realization of the advantages of the outer layer on the whole surface of the plastic preform and the subsequently manufactured container, regardless of the print image to be applied subsequently. If the outer layer is applied only to certain areas on which, for example, also the print image is applied later, it is possible to realize a considerably more economical print.

In an advantageous further development the method is characterized in that the behavior of the outer layer with respect to being wetted with printing inks is better than the behavior of the surface of the plastic preform with respect to being wetted with printing inks. Thus, also the quality of the produced print image is improved.

In another embodiment the method includes in that the outer layer is at least stretchable and transparent. If the printing layer is applied, for example, with a corresponding material thickness, such that the whole outer surface of the plastic preform is still covered by it even after the stretching, and if it is at the same time transparent, it provides for the corresponding advantages over the whole surface of the produced plastic container during the recycling process, while there are no disadvantages with respect to the producible print images, as it is transparent.

It is provided in one embodiment that at least one physical property of the outer layer is changed during a downstream stretch blow molding process. Thus, it is possible to apply first an outer layer having specific physical properties, which may then be deliberately changed later, e.g. depending on the temperature of the stretch blow molding process or other parameters.

It is an advantage if the outer layer has a melting temperature of at least 75° C. and/or that the surface energy of the plastic preform coated with the outer layer is between 30 mN/m and 60 mN/m, preferably between 38 mN/m and 46 mN/m. At a correspondingly chosen melting temperature the outer layer may be (slightly) liquefied once more during the stretch blow molding process, which may result in a better distribution of the outer layer on the plastic container being formed. If the outer layer of the plastic container has the surface energy according to this embodiment the wetting properties with printing ink are improved significantly, so that the quality of the print images being formed is better compared to an application thereof on the original plastic container without an outer layer.

It is an advantage if the material of the outer layer undergoes a phase transition in a temperature range of 120° C.-140° C., wherein at least one of the following properties changes: state of aggregation, optical properties, haptics, barrier properties, wettability with water or water-containing solutions. A corresponding targeted phase transition allows the change of the properties of the outer layer in a well defined manner.

It is possible with the present disclosure to realize an apparatus for producing a plastic preform, where the apparatus includes a transport device for the transport of the plastic preform a first device for producing a plastic preform and a second device for applying an outer layer to the plastic preform, and the apparatus is suited for producing a plastic preform according to an above-described embodiment. This apparatus allows the realization of a plastic preform, with corresponding properties of the outer layer according to above-described embodiments.

In one embodiment the apparatus may include that the second device is arranged downstream of the first device in the transport direction. This arrangement of the device ensures that the outer layer is only applied to the already finished plastic preform.

In one embodiment of the apparatus the second device includes a rolling device or a spraying device or a dipping device or a direct printing device or a plasma deposition device or a device for combustion chemical vapor deposition or a flush coating device, which are suited to apply the outer layer to the plastic preform. The use of these devices provides for advantages with respect to the production of outer layers, which are applied either to the whole surface of the plastic preform, or only to partial areas.

It may be provided that the material of which the outer layer is made is a lye-soluble polymer, or contains same. The use of lye-soluble polymers as outer layer proves to be advantageous in view of the recycling process of a plastic container produced from the plastic preform.

It is possible to realize a recycling process for plastic containers, in particular PET containers, having an outer layer which is bonded to the plastic container and a printing layer, wherein the outer layer is insoluble in aqueous solutions having a pH-value between 3 and 10, and well soluble in aqueous solutions having a pH-value in a range of more than 10, and where the plastic container is shredded, and a removal of the outer layer from the shredded plastic container is realized by means of nucleophilic substitution. In this recycling process the advantages of the outer layer applied to the plastic preform may be utilized.

An embodiment of the recycling process may include that the removal of the plastic layer is realized in a recycling solution having a pH-value of more than 10, wherein the recycling solution contains NaOH. Due to the removability of the outer layer in solutions having pH-values of more than 10 the outer layer is easily removable if solutions containing NaOH are used.

### BRIEF DESCRIPTION OF THE FIGURES

FIG. 1 shows a schematic view of an apparatus for producing a plastic preform according to the disclosure.

FIG. 2 shows a schematic view of a plastic preform according to the disclosure.

FIG. 3a shows schematic views of the change of the outer layer during a stretch blow molding process.

FIG. 3b shows another schematic views of the change of the outer layer during a stretch blow molding process.

FIG. 4 shows a schematic view of a printing method.

### DETAILED DESCRIPTION

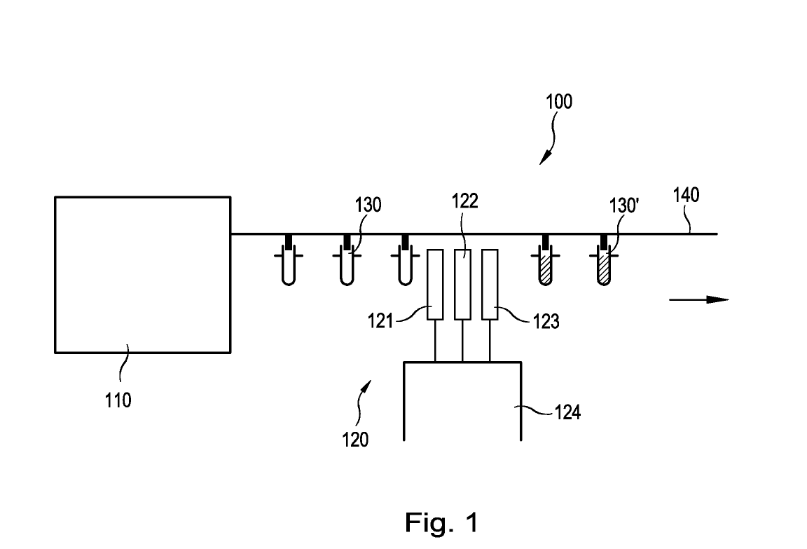

FIG. 1 shows an apparatus 100, by means of which a plastic preform 130 may be produced and provided with an outer layer. To this end, the apparatus 100 comprises a first device 110 in which, for example, a plastic preform 130 is produced by means of an injection molding process. This production can be accomplished by using known methods. That is, the production of the plastic preform 130 is, in the appropriate case, not limited to injection molding technologies, but may also be realized in different ways. Furthermore, all variations of the injection molding process may be realized in device 110. Thus, it is possible, for example, to produce a multilayer preform 130 in the device 110 by means of the injection molding process, the preform 130 having, for example, two, three or more layers of different thicknesses forming the total material thickness. The plastic preforms 130 may then be transported, e.g. in the neck handling process, to a second device 120 in which the preforms 130 are provided with the outer layer according to the disclosure. To this end, one or more devices 121-123 may be provided, which are capable of applying the outer layer to the container by using different methods, respectively, method steps. The devices 121-123 can be, for example, direct printing modules which print the outer layer onto the preform 130. To this end, an ink feed tank 124 may be provided, in which the corresponding material for the outer layer is held available. It is also possible to use other devices for applying the outer layer to the plastic preform. For example, rolling or spraying devices, or dipping devices or plasma deposition devices as well as combustion chemical vapor deposition devices or flush coating devices may be employed. All of these devices have different advantages. Also, these devices may be utilized in appropriate combinations.

It is basically advantageous if devices are used that are suitable for applying layers to large areas of the plastic preforms if the outer layer is intended to extend across the whole outer surface (i.e. not the surface on the inside of the plastic preform), while other devices, e.g. direct printing devices, are preferably used if the outer layer is to be applied only to specific areas of the plastic preform.

The plastic preforms 130′ now provided with the outer layer may then be transported by another conveyor 140, e.g. in a neck handling process, or by introducing a corresponding mandrel, to subsequent container handling units. The preforms may, in particular, be passed on to a stretch blow molding device in which their size is adapted to the size of the plastic containers to be produced from the plastic preforms.

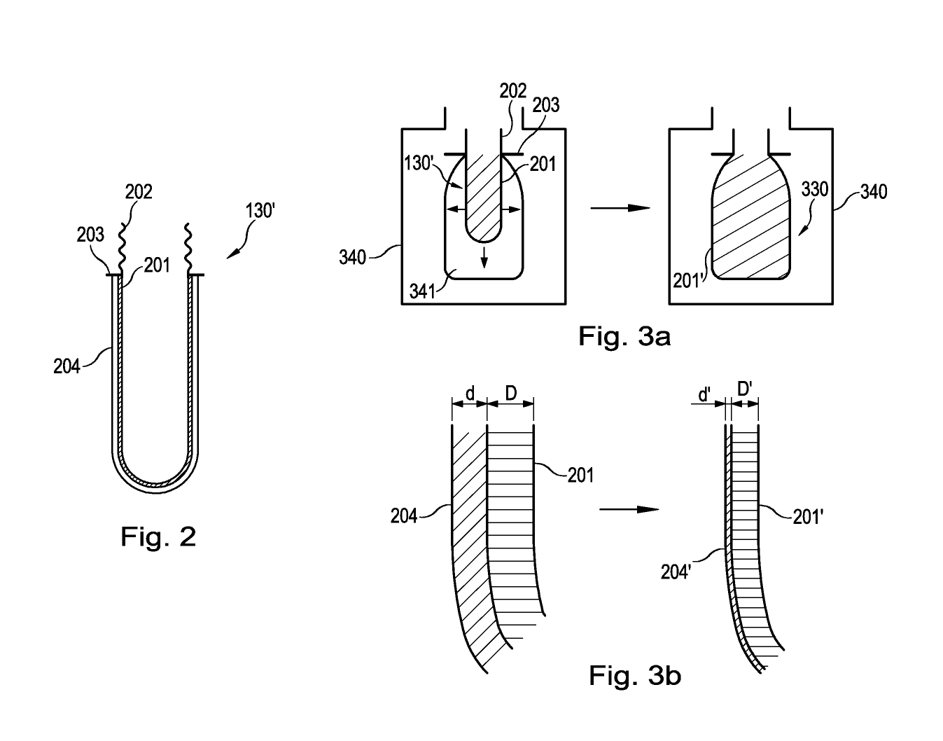

FIG. 2 shows a plastic preform 130′ having an outer layer, as produced according to the method described in FIG. 1 and by the corresponding apparatus. This plastic preform 130′ comprises, as usual, a thread 202, in most cases a carrier ring 203, and a stretchable container region 201 which will be referred to as preform body 201 below. The thread 202 and the carrier ring 203 usually maintain their shapes in the subsequent production process of the whole container (e.g. the stretch blow molding process), and only the preform body 201 is blown up. As, in most cases, only the blown up preform body 201 is used for the printing of the subsequently obtained container, it is provided that the outer layer 204 is applied only to this portion of the preform.

The outer layer 204 is applied to the preform body 201 according to the methods described in FIG. 1. It is also conceivable that the outer layer 204 is applied to the whole outside of the preform body, on the full circumference thereof. Preferably, the outer layer 204 is made of a lye-soluble polymer which forms a solid bond with the preform body 201. In any case, the outer layer is made of a material which, at least after the final shape of the complete plastic container is obtained, is insoluble in solutions having a pH-value between 3 and 10, and well soluble in solutions having a pH-value of less than 3 and/or more than 10. Thus, it is guaranteed that the outer layer of the container, to which also the print image is then finally applied, does not come off under normal circumstances (i.e. in the ordinary use of the plastic container).

It is furthermore advantageous if the material of which the outer layer 204 is made allows a wetting with corresponding printing inks. The result is here clearly better as compared to a direct application of the printing ink to the preform body 201. In this context, clearly better means that the quality of the print image applied to the outer layer is greater than that of a comparable print image that is directly applied to the container surface. The print image being formed may here be characterized by sharpness, the general coloring, contrast or other properties as compared to printing on the surface of the actual container. Also, it is not necessary to improve the print image in respect of all properties. Basically, the advantage in applying the outer layer 204 resides in the fact that, in a recycling process using for example an NaOH solution, it can be removed much more easily, together with the printing layer, from the plastic flakes into which the containers are commonly shredded, as compared to the removal of the printing ink from the container surface itself.

The outer layer 204 illustrated in FIG. 2 is represented without any gaps on the outer surface of the preform body 201. Depending on the method of applying the outer layer 204 it is also possible, however, to apply the outer layer only to specific areas of the preform body 201. In this case, it should be considered that the size and shape of the so localized outer layers 204 may be subjected to alterations in the production process of the whole container, e.g. during the stretch forming process. In particular, the corresponding areas provided with the outer layer 204 are lengthened and widened during the stretch blow molding process. However, as the surface deformation occurring during the stretch blow molding is known, as both the target body and the starting body are known, this may already be taken into account when only a partial outer layer 204 is applied.

FIGS. 3a and 3b correspondingly show the changes undergone by the outer layer and the preform body 204, respectively, 201 during the stretch blow molding process, whereby the preform 130′ is turned into a fully formed container 330 in FIG. 3a. To this end, the preform 130′ is introduced into a blow mold. The carrier ring 203 and the thread 202 are not altered by the treatment in the blow mold. To this end, they may be kept, for example, in a holder outside the blow mold, which is cooled so as to avoid a deformation of the material in this area. The preform body 201, however, is completely introduced into the blow mold 340. The inner surface of the blow mold is adapted to correspond to the shape and size of the container to be produced. By using known blow molding methods the preform body is then brought into the final shape 330, e.g. by stretching or blowing up at an increased temperature, with the preform body 201 lying against the inner surface of the blow mold.

Usually, the temperature of the preforms 130′, or at least the preform bodies 201, is increased in the stretch blow molding process. In most cases, the temperature is in a range between 120° C. and 140° C. In this range, the base material used for the preform 130′ is fluid, but not entirely liquid, so that it is possible to alter the shape of the preform 201 without causing cracks in the surface. At this known temperature, which is basically used in the production process of the plastic container, it may be advantageous if the outer layer 204 is made of such a material that ensures a (irreversible) phase transition of the outer layer 204 with respect to some properties once this temperature is reached, such as, for example, an interaction with light (transparency and reflectivity, as well as diffusing behavior). This phase transition may be, but does not have to be, a first-order phase transition. A first-order phase transition is preferred, however, as a certain behavior may ensue abruptly when the critical temperature is reached.

FIG. 3b shows the changes undergone, during the stretch blow molding process, by the container wall, respectively, the preform body 201 from FIG. 3a in a cross section. In the illustration of FIG. 3b pertaining to the preform body the outer layer 204 and the wall of the preform body 201 have a thickness d, respectively, a thickness D. Basically, the outer layer 204 will be clearly thinner than the wall 201 of the preform body. Typical thicknesses for the outer layer are in the range of some 10 to 100 μm, while the typical thickness D of the preform body 201 amounts to several millimeters, e.g. up to 3 mm. During the stretch blow molding process the thickness of the wall of the preform body is reduced to thickness D′, and the thickness of the outer layer 204′ is reduced to thickness d′. As the surface area enlargement undergone by the preform body during the stretch blow molding process is basically known, the layer thickness d of the outer layer 204 to be applied can be chosen correspondingly, so that the whole outer layer has the desired thickness d′ after the stretch blow molding process. It may be provided, for example, that the thickness of the outer layer amounts to 5 to 20 μm, preferably 5 to 10 μm, after the stretch blow molding process.

As the stretching of the PET body 201 during the stretch blow molding process takes place very rapidly, and the temperature fluctuates to a great extent, it is advantageous if the material of the outer layer 204′, too, can withstand corresponding loads, without the occurrence of material damages, e.g cracks, into which printer ink might penetrate later in an undesired manner. Accordingly, specific polymers may be used for the outer layer, which are temperature-resistant and preferably have a melting temperature of 75° C. or more. In particular, materials are preferred which, like the used plastic material, undergo a glass transition in a temperature range between 80° C. and 140° C. As it can thus be ensured that the outer layer 204 has a similar physical behavior as the wall of the preform undesired strains between the outer layer and the finally shaped plastic container can be avoided, so that the likelihood of the occurrence of undesired cracks is reduced.

Even though the above description only related to the application of the outer layer 204 to the outer surface of the PET body 201, it may also be provided in one embodiment that a layer is applied also to the inside of the preform body 201. This layer need not necessarily have the same properties as the layer 204 applied to the outside. It may be provided, for example, to improve the plastic material, of which the actual container is formed, in respect of barrier properties, e.g. the transfer of gases. In addition, it may be used to fulfill specific sterility criteria. To apply a corresponding layer to the inside of the preform a pressure head may be introduced, or a corresponding liquid containing the coating material may be introduced into the preform. Here, it may be provided that the material is polymerized at a certain temperature when contacting the inner surface of the preform, or forms a bond with the inner wall of the preform. Thus, an inner surface is created, which has a uniform thickness. Advantageously, plasma deposition process may be used as well.

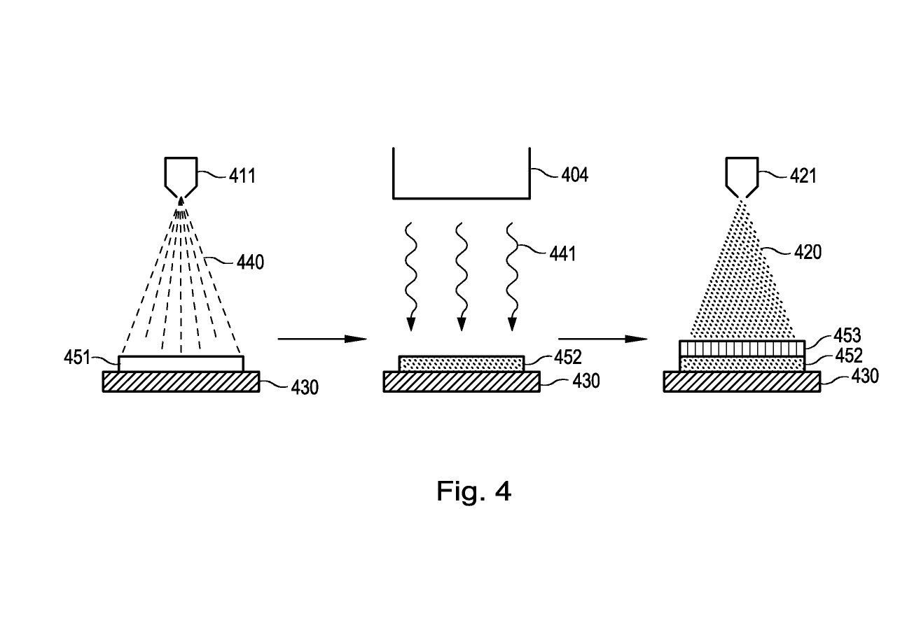

FIG. 4 schematically shows the complete treatment of the preform up to the print image, respectively, additional intermediate steps. The process steps shown in FIG. 4 need not be the only process steps that are performed.

According to FIG. 4, initially the outer layer 451 is applied to the outer wall of the preform 430. This can be realized by means of the above-described processes, e.g. direct printing process or plasma deposition process. The outer layer 451 may be applied only onto a partial area of the preform, or to the whole outer wall of the preform. Subsequently, the preform, provided with the outer layer, is adapted to the size of the actual plastic container, e.g. in a non-illustrated stretch blow molding process. In the third method step as illustrated, the print image 453 can then be applied, for example, by corresponding direct printing modules 421. To this end, the printing ink 420 is applied only to specific areas, or to the whole outer wall of the plastic container provided with the outer layer.

It may be provided that the outer layer 451 is treated prior to the application of the printing ink 453, either during the stretch blow molding process or another method step, so as to be changed into a modified outer layer 452. In addition to the modifications of the outer layer during the stretch blow molding process by the influence of the temperature, as described above, it is also possible to use, for example, irradiation with ultraviolet rays so as to deliberately manipulate the properties of the outer layer. To this end, the container provided with the outer layer 451 is passed into an irradiation unit 404 and exposed to radiation 441. It is advantageous if the material, of which the container is made, is transparent to the radiation used. Thus, it is possible to deliberately alter properties of the outer layer 451 and transform it to a modified outer layer 452, while the container itself remains unchanged.

Basically, it is provided that the properties of the outer layer are chosen such that the outer layer forms a stable bond with the surface of the plastic container, on the one hand, which can be removed from the plastic container in common recycling processes, however, e.g. shredding the plastic container into plastic flakes and subsequently washing same in a NaOH-containing solution having a pH-value of more than 10. On the other hand, the outer layer 252 is formed such that the printing ink forms a stable bond with the outer layer, whereby this bond itself need not be removable even in common recycling processes as the print image can be removed from the container surface together with the outer layer by using, for example, NaOH solutions, meaning that the outer layer, when removed from the surface of the plastic container, carries the printing layer with it.

For this to be achieved, it may also be provided that the method for producing the plastic preform with the outer layer is performed in several stages. Thus, the surface of the plastic preform, or preform, may be used to serve as a substrate for a first outer layer which, for its part, forms a bond with the surface of the preform that complies with the recycling requirements. A second outer layer can be applied to this first outer layer subsequently, wherein this outer layer may be wetted with the printing inks used in a particularly favorable manner. A corresponding two-layer system may help to ensure the opposed requirements (removal from the surface of the plastic container and, at the same time, good wetting capacity and adhesion of the printing inks). For the actual recycling process it is then of relevance only that the lowermost layer, which forms a bond with the plastic container, can be removed from same in the recycling process. Insofar, the method is not limited to the application of only one outer layer or two. Even a complicated multilayer system is conceivable, whereby it is also possible that some layers are applied only to certain portions of the surface of the plastic preform, respectively, to the underlying outer layers so as to take into account certain requirements. For this to be realized, several devices 121-123 then have to be provided in the second device described in FIG. 1, which applies the outer layer, which devices apply the outer layers to the plastic preform. This, too, can be accomplished by the most different processes for each outer layer, so that the devices 121-123 may, by all means, be different in view of the technology used for applying the respective outer layer and in view of the material used. Each of the devices 121-123 may furthermore provide different areas of the preform with a corresponding outer layer. In such a case, the feed tank 124 preferably comprises a separate feed tank for each of the devices 121-123.

1. A method for producing a plastic preform, comprising a first step of a production of a plastic preform from raw material, and a second step of applying an outer layer to the plastic preform, and the outer layer forms a bond with the plastic preform, and is insoluble in aqueous solutions having a pH-value between 3 and 10, and well soluble in aqueous solutions having a pH-value in a range of less than 3 and/or more than 10.

2. The method according to claim 1, and the first step comprises the production of a plastic preform by an injection molding process.

3. The method according to claim 1 and the outer layer is applied to the plastic preform by at least one of the following method steps: rolling, spraying, dip coating, direct printing, combustion chemical vapor deposition, plasma deposition, electrostatic coating.

4. The method according to claim 1, and the outer layer is applied either to a portion of the outer surface of the plastic preform or to the whole outer surface of the plastic preform.

5. The method according to claim 1, and the behavior of the outer layer with respect to being wetted with printing inks is better than the behavior of the surface of the plastic preform with respect to being wetted with printing inks.

6. The method according to claim 1, and the outer layer is at least stretchable and transparent.

7. The method according to claim 1, and at least one physical property of the outer layer is changed during a downstream stretch blow molding process.

8. The method according to claim 1, and the outer layer has a melting temperature of at least 75° C. and/or that the surface energy of the plastic preform coated with the outer layer is between 30 mN/m and 60 mN/m.

9. The method according to claim 1, and the material of the outer layer undergoes a phase transition in a temperature range of 120° C.-140° C., and at least one of the following properties changes: state of aggregation, optical properties, haptics, barrier properties, wettability with water or water-containing solutions.

10. An apparatus for producing a plastic preform, comprising a transport device for the transport of the plastic preform, a first device for producing a plastic preform and a second device for applying an outer layer to the plastic preform, the apparatus is suited for producing a plastic preform according to claim 1.

11. The apparatus according to claim 10, and the second device is arranged downstream of the first device in the transport direction.

12. The apparatus according to claim 10, and the second device comprises a rolling device or a spraying device or a dipping device or a direct printing device or a plasma deposition device or a device for combustion chemical vapor deposition or a flush coating device, which are suited to apply the outer layer to the plastic preform.

13. The apparatus according to claim 10, and the material of which the outer layer is made is a lye-soluble polymer, or contains a lye-soluble polymer.

14. A recycling process for plastic containers, having an outer layer which is bonded to the plastic container and a printing layer, the outer layer being insoluble in aqueous solutions having a pH-value between 3 and 10, and well soluble in aqueous solutions having a pH-value in a range of more than 10, comprising shredding the plastic container, and removing the outer layer from the shredded plastic container by means of nucleophilic substitution.

15. The recycling process according to claim 14, and removing the plastic layer utilizes in a recycling solution having a pH-value of more than 10, and the recycling solution contains NaOH.

16. The method according to claim 8, and the surface energy of the plastic preform coated with the outer layer is between 38 mN/m and 46 mN/m.

17. The recycling process according to claim 14, and the plastic container comprise PET containers.
